(19) United States
(12) Patent Application Publication
(10) Pub. No.: US 2007/0044802 A1
(43) Pub. Date: Mar. 1, 2007

(54) Filtering and humidifying face mask

(76) Inventors: Marilyn B. Horne, New York City, NY (US); Charles D. Ray, Santa Barbara, CA (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/502,610

(22) Filed: Aug. 10, 2006

Related U.S. Application Data
(60) Provisional application No. 60/706,922, filed on Aug. 10, 2005.

(51) Int. Cl. A62B 23/02

(52) U.S. Cl. 128/206.19

(57) ABSTRACT

A filtering and humidifying face mask is disclosed. The face mask includes a base mask and an outer mask removably secured to the base mask. The outer mask selectively retains at least one filtering layer and at least one humidifying layer. In this regard, upon donning the face mask, a wearer can remove and replace at least one of the filtering layer(s) and the humidifying layer(s) without altering a position of the base mask.

### CROSS-SECTION TO RELATED APPLICATIONS

This application claims priority to U.S. Provisional Application Ser. No. 60/706,922, filed Aug. 10, 2005, the teachings of which are incorporated herein by reference in their entirety.

### FEILD OF THE INVENTION

Aspects of the present invention relate to filtering and humidifying face masks, and more particularly, to filtering and humidifying face masks permitting a convenient replacement of at least one layer of the face mask without a wearer removing the entire face mask from the wearer's head.

### SUMMARY

One aspect of the present invention provides a filtering and humidifying face mask. The face mask includes a base mask and an outer mask removably secured to the base mask. The outer mask selectively retains at least one filtering layer and at least one humidifying layer. In this regard, upon donning the face mask, a wearer can remove and replace at least one of the filtering layer(s) and the humidifying layer(s) without altering a position of the base mask.

Another aspect of the present invention provides a method of humidifying inhaled air. The method includes first donning a face mask, where the face mask includes a base mask and an outer mask removably secured to the base mask. In this regard, the outer mask selectively retains at least one filtering layer and at least one humidifying layer. The method further includes periodically replacing one of the filtering layer and the humidifying layer without altering a position of the base mask.

In one embodiment, the mask of the present invention has soft, conforming margins that are easily and comfortably positioned on the wearer's face and maintained in position using suitable elastic means. The elastic means can include straps that are passed around the head or ears and attached to the mask margins by simple removable fastening means. Once in position it is not necessary to remove or reposition the mask for prolonged periods unless this is required for other reasons, such as, washing the face, eating and drinking or respiratory cleansing by sneezing or vigorous coughing with expectoration. The filters or moisturizing pads are exchanged as often as desired by the wearer, and can be accomplished without disturbing the position of the mask on the face or head by opening a simple flap hinged on the lower margin of the mask. This maneuver is aided, for example, using a simple cosmetic mirror.

Additional replacement filters and pads are stored and the moisture maintained in a separate, simple but suitable waterproof container making the exchange of filters and pads an easy and secure task. This separate, ancillary compartment for moisturizing pads is appropriately filled with water and possibly additional medicinal or perfumed substances as needed by the user. A simple humidity indicator (a color changing card or like material suitably attached to the mask) indicates the residual moisture content of the mask giving good evidence when it is time to change the pad. The outer jacket of the mask may be of neutral color or covered by a printed, decorative cloth of high airflow characteristics; this cover may be changed to suit the desires of the wearer.

### BACKGROUND OF THE INVENTION

The size of airborne particles determines, to a major extent, how far into the respiratory system the particles may pass and then lodge. Particles smaller than a few microns, including those of viruses and solvent vapors and smoke, easily reach the respiratory alveoli, or air sacs where the exchange of oxygen traverses the cell membranes to enter the blood circulation. In contrast, large particles lodge in the nasal passages, throat or bronchi where they may be blown out, coughed up and expectorated. The smaller particles cannot be forced out readily and noxious ones may cause damage or inflammation aggravated by the dryness of the inhaled air. The problem of filtration of airborne particles has long been successfully addressed through a number of established medical, family-personal and industrial masks made of filtering non-woven fabrics or papers. Certain of the presently available masks can filter out particles as small as 0.1 microns (the size of certain viruses and bacteria or extremely very fine dust or smoke particles). Further, a few masks are currently available in which the filtering material can be moistened directly or indirectly to maintain a minimal level of humidification, but not for more than several minutes in a dry air environment. If moisturizing pads are held inside such masks, as they dry out and need replacement, it requires first removing the mask and the moisturizing pad then wetting the pad, replacing it in its position within the mask, and then subsequently reapplying the mask to the face. However, during air flights of a few to several hours, if a reasonably useful and comfortable level of inhaled air humidification is to be obtained, a substantial volume of water will be continuously needed requiring several repetitions of this task.

Many wearers, particularly women having carefully coifed hair, object to removing the mask and its retaining elastics, disturbing their coiffure and cosmetic make-up required in placing and replacing the elastic head bands or other means holding the mask in a comfortable position.

With the above in mind, improvements to face masks that enable more effective dry air humidification will be welcomed by airline travelers and others.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 illustrates a filtering and humidifying face mask according to one embodiment of the present invention. In this regard, FIG. 1 illustrates a diagrammatic frontal view of a wearer having the novel base and outer mask portions in a comfortably suitable position on the face. Gentle but adequately forceful elastic straps pass around the ears and may extend to traverse the back of the head and neck, these straps being removable and adjustably fixable using fabric hook and loop or other suitable means for attachment. The outer portion of the mask opens by a hinge along its lower edge and is held in place by a friction tab at the bridge of the nose. The non-woven fabric comprising the hinged outer portion is highly permeable to flowing air. The contour of the base and outer mask portions are maintained by suitable, highly perforate structural members.

FIG. 2 illustrates a lateral diagrammatic side view of the novel mask in position on the face showing the soft, conforming and manually adjustable margins of the base mask so that a contour having comfort and air tightness are achieved. Also shown is an optional posterior web attachment bridge for the elastic straps serving to maintain a stable and comfortable orientation of the separate straps.

FIG. 3 illustrates a lateral diagrammatic partially transparent view of the basic structure of the outer and base mask portions relative to the anatomy of the face. A substantial open chamber is established in front of the structures of the nose and mouth. Soft conformal margins of the mask are indicated as well as the hinge traversing the base of the mask at the chin.

FIG. 4 illustrates a lateral, partially transparent diagrammatic view of the base and outer portions of the mask illustrating the separated slotted compartments holding the filter and humidifying pad in position. Also diagrammed are the structural members that maintain the contour of the base and outer mask portions, the close fitting junction of the two portions and the hinge openably uniting these portions. The diagrammed filter, moist pad and their respective holding slots are illustrated in central cross-section whereas the lateral portions of these will follow the curving facial contour.

### DETAILED DESCRIPTION OF THE INVENTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

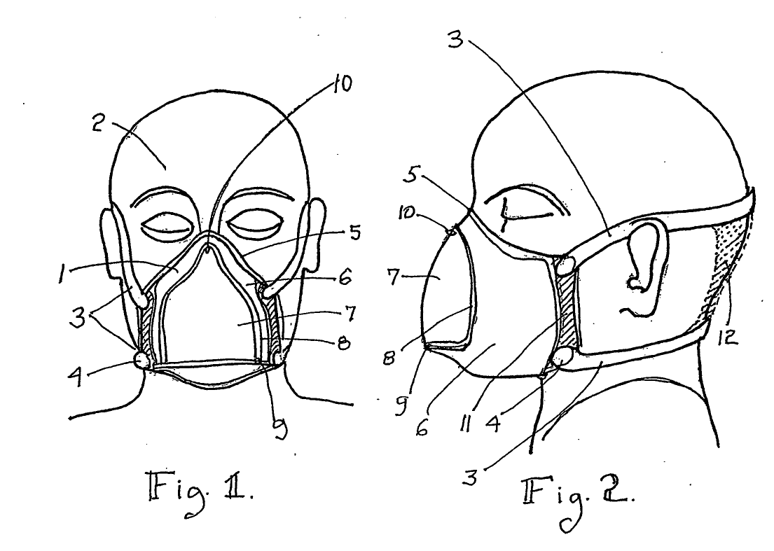

FIGS. 1 and 2 illustrate diagrammatically one embodiment of a facemask 1 in accordance with the present invention including a base (or base mask) 6 and outer portion (or outer mask) 7. In some embodiments, the outer portion holds removable filter(s) (or filtering layer(s)) and humidification pad(s) (or humidifying layer(s)) in suitable position a suitable distance away from the facial anatomy of a wearer 2. Margins of the mask portions are, in one embodiment, of a soft, manually bent and conformal polymer (i.e., a flexible foam seal) permitting a close, comfortable facial skin interface that is airtight and water retaining. Suitable thin, open mesh or contoured, support maintaining internal structures have slots provided to suitably hold the margins of the filter and pad components. With reference to FIG. 1, the mask 1 is positioned on the face of the wearer 2 and held in position using gentle but sufficiently forceful elastic straps 3 attached to the base 6 4 with a hook and loop fastening system or other suitable means represented generally at 4. Margins 5 of the base 6 are bonded with a soft, compliant but adjustable material that in one embodiment encircles the base 6. As described in greater detail below, the outer mask 7 is hingedly secured to the base 6 and holds a filter and/or humidifying pad. Regardless, margins 8 of the outer mask 7 are also, in one embodiment, suitably bonded with a soft and compliant polymer, making a separable airtight union between the base 6 and outer mask 7. For example, in one embodiment a lower hinge 9 permits a forward opening of the outer mask portion 7 relative to the base 6 for access to the internal filtering and/or humidifying components, as described below. In one embodiment, the outer portion 7 is held in a closed position relative to the base 6 by a friction catch means 10 mounted on the base mask 6 at a point corresponding with the bridge of the wearer's nose.

Now with reference to FIG. 2, shown from a side view is the relationship between the base 6 and outer 7 mask portions. The elastic straps 3 are suitably attached by a fabric hook material or other suitable means 4 to the posterior margin of the base mask 6 via a margin of fabric loop material 11 or other suitable means formed on the base 6. The elastic straps 3 may be provided with an optional posterior web strap 12 holding the straps 3 in a more fixable relationship.

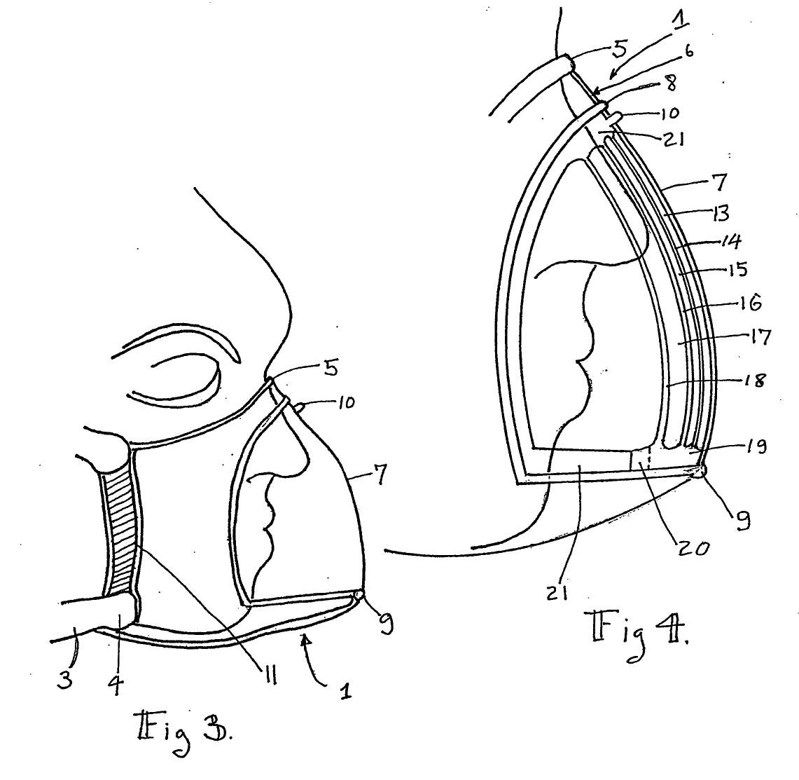

Now with reference to FIG. 3, shown in a semitransparent side view are the relationships between the mask 1 assembly and the anatomy of a wearer's face. The suitably adjustable and removable elastic straps 3 having removable and adjustable attachments to the base 6 using the hook and loop fabric 11 or other suitable means are again shown, as are the soft, conforming polymer margins 5 of the base mask 6 and the forward contour of the outer mask 7 hinged at its inferior margin 9 and removably fixed in its closed position by a friction catch 10 at a point corresponding with the bridge of the wearer's nose.

FIG. 4 illustrates the outer 7 and base 6 as well as the means to hold and support the internal components to filter and humidify the respired air. The soft, conformal margin 5 of the base mask 6 is again shown in contact with the facial skin (not numbered). The outer mask 7 having the similar soft margin 8 is also shown. The hinge 9 at the inferior margin of the outer mask is also again indicated, as is the friction catch 10 holding the outer mask 7 in a firmly closed position relative to the base 6. The outer shell or perimeter of the outer mask 7 is supported against deformation or collapse by being attached to an internal support 13 that in one embodiment is formed as an open web or mesh of suitable metal or polymer.

In one embodiment, the outer portion 7 maintains a filter layer 15 and a humidifying sponge layer or pad 17. To this end, the outer mask 7 includes a second supporting separator 14 extending from the internal support 13 and forming an outer compartment wall for the filter 15. The filter 15 is retained relative to the second separator 14 by an internal wall 16 that also acts as the outer wall for the humidifying open cell sponge pad 17 that is further supported by an internal wall 18.

Each of the separators is, in one embodiment, highly perforated (i.e., porous) to permit substantially unrestricted airflow. The upper or lower portion of the respective retaining walls 14, 16, 18 are open to facilitate replacement of one or both of the filter 15 and the pad 17. The opposing portion of the retaining walls 14, 16, 18 are closed to maintain the filter 15 and the pad 17 at the desired position within the outer mask 7. For example, the retaining walls 14, 16, 18 are permanently attached at their bases to a common base 19 that overlaps (indicated at 20) with a perimeter 21 of the outer mask 7. The internal rims of the two mask portions 6, 7 create an airtight fitting of the two portions when closed and held in position by the friction catch 10.

The depicted retaining walls and component filter and pad are shown in forward cross-section, although the retaining walls and retained components continue in an arcuate form laterally following the contour of the wearer's face. The base hinge 9 is less curved, however, providing a spring-like return force to the opened outer mask. The free space between the mask 1 and wearer's face provides for improvement in breathing. The filter 15 and the pad 17 can assume a wide variety of shapes, sizes, and forms, with the mask 1 being configured to accommodate the selected filter 15 and pad 17. In addition, multiple ones of the filter 15 and/or pad 17 can be provided in accordance with the present invention.

Not shown is an optional small humidity indicator that can be mounted anywhere laterally on either mask portion 6 or 7 provided that the chosen position provides clear indications and does not interfere with the structure or operation of the mask 1. The indicator unit's color changing that suitably reflects high and low relative humidity, to determine when the humidification pad requires servicing or changing, is observed using a small cosmetic mirror since its visible port will not be in the wearer's direct line of sight. Additionally, in accordance with an alternative embodiment, not shown is a simple two-compartment waterproof carrying pouch to hold filters and pads, whereas the filter compartment is dry and the pad compartment is partly filled with water, and the closure of which is watertight. The outer mask 7 may be of a suitable, porous colored or patterned/designed fabric.

Method of Use

The wearer can practice using the mask 1 at first in privacy to become familiar with the application, adjustments and checks for comfortable fitting, air tightness and appropriate contouring of the mask on the face. The wearer should also practice positioning the retainer strap means suitably and comfortably around the head, hair and ears (it being noted that the strap can be positioned behind or over the wearer's ears). This practice is done while standing before a suitably large mirror placing and adjusting the mask and means for attachment. If not performed in advance of airline flight (or other intended location of use), the wearer may apply the mask 1 while standing before the lavatory mirror of the aircraft.

When in actual use, the mask 1 will often remain in place for several hours so it should both be practiced in advance and then applied with concern regarding both fitting and comfort. The soft margins 5 of the mask 1 improve both air tightness and comfort so these margins 5 around the mask rims are manually adjustable to attain the best soothing position. The wearer appropriately applies the mask and makes I suitable adjustments then opens the outer portion 7 and places or replaces the filter 15 and humidifying pad 17, taking them from the their protective, waterproof ancillary pouch container in accordance with one alternative embodiment. If the air passage seems to become partially obstructed, the filter 15 can be replaced since it may still contain obstructive excessive filtration material from its last use or there may be some positional pressure on the nose.

While the mask 1 had been kept in its carrying container, the humidity indication (where provided) should be “dry.” After placing the moistened pad 17, within a minute or so of respiration the indication should be “wet.” A preferred indicator is used, meeting SAE AS26860 and MiL-1-8835 or equivalent requirements. (Available as color reversible inorganic salts sensitive to humidity changes, generally of cobalt silica blue-pink or iron yellow-orange silica gel compounds). Following approximately an hour of wearing the mask 1 and its continued humidification of inhaled air drying of the pad 17 will occur, depending on the relative humidity of the ambient air and the respiratory rate. Appropriately, the indication will change to “dry” thus showing the wearer the need to wet the pad 17 or exchange the dry pad for a wet one. In addition, at this same time, the wearer will also become aware of the loss of humidity and can touch the outer surface of the mask I to determine the remaining wetness of the pad 17. The changing of filter 15 or pad 17 is accomplished by opening the outer portion 7 under indirect vision using, for example, a hand held cosmetic mirror. As desired, a suitable medicament or aromatic substance (i.e., an aromatherapy additive) may be added to the pad 17 rewetting water or solution.

Given a short training period and printed literature to read, wearers are both informed on proper use and care of the device 1 and also warned regarding potential failure or damage to the system. Wearers are informed to discontinue its use should respiratory issues arise, or the mask 1 becomes inoperable or significantly damaged.

Following use, the filter 15 and pad 17 are removed and discarded and should not be stored while wet, which may encourage fungus formation and possible damage to the humidity indicator (where provided).

Example of Use

One investigator, a professional Metropolitan opera singer, has had difficulties with dry voice and occasional viral colds following long airline travel.

She has found that using a moist cloth placed inside a standard over-the-counter dust mask has helped substantially, although several changes of the wet cloth proved cumbersome and often, at first, ran water down her face. Further, placing, removing and replacing the standard mask caused discomfort and derangement of her coiffure, details often requiring reparations afterwards. The novel device grew out of seeking a suitable solution to this problem. The use of the device 1 is remarkably simple and the details about its proper utility and after care are easily learned and practiced. The novel mask 1 should be cleaned gently with mild soap and water (an antibacterial soap is particularly recommended) and dried before returning to its container. No other maintenance is required. The humidifying water may be distilled or otherwise sterilized and completely removed from the storage reservoir when not in use to discourage mold or bacteria formation.

Additional users include mouth breathers who habitually or as a result of changes in the nasopharyngeal passages (by a cold, the flue, allergies, trauma or plastic surgery to the face) must breathe with an open mouth during the day or particularly at night. Workers in very dry, dusty and unpleasant air situations or at high altitudes can find good use of the novel device to reduce nasopharyngeal dryness and irritation. The device may be used, with installation of suitable medicaments in the moisturizing solution, as a minimal level therapeutic respirator. The attachment of a tube with flowing dry oxygen gas inside the mask facial compartment can operate in tandem with the humidifying mask.

Advantages

The invention therefore has several novel advantages over existing facemasks, including the ability to suitably maintain humidified inhaled air in an otherwise low humidity environment, while also removing potentially noxious particles that may be suspended in the dry air. The residual content of humidifying water in the moistening pad is indicated by a simple means that produces a small, visible change, easily monitored by the wearer. No other facemask has this capability.

The removably adjustable attachment and stabilizing means maintain the proper comfortable position of the mask while the front access portal is visibly opened for the replacement of filters or pads as needed, there being no need to detach and replace the mask, as such would disturb the coiffure of the wearer, presently the case with all other face masks used for filtration or humidification. The certainty regarding the maintenance of a continuous humidification with filtration provided by the novel mask is unmatched.

While the preferred embodiments of the invention have been described, it should be understood that various changes, adaptations and modifications may be made therein by those skilled in the art without departing from the spirit of the invention and the scope of the appended claims.

The novel face mask relates to the alleviation of potential upper respiratory illness or encumbering dryness of nasal, pharyngeal and respiratory membranes in dry atmospheres, particularly in an atmosphere having floating particles that may harbor infections or allergenic agents and more particularly during air travel. For example, the more rarified air within airline cabins (even though appropriately pressurized) ordinarily has a relative humidity from 12 to 20%, generally equal to that of desert air. This low relative humidity is due to the intake of high altitude air at extremely low outside temperatures, which after pressurization and heating to a comfortable ambient cabin temperature around 75 degrees Fahrenheit, leaves very little moisture in the air.

Such dry air, having limited ability to dissipate the surface electrical charges of small airborne particles, permits them to float freely in the cabin being breathed in and out by numerous passengers. These particles, as fomites, may therefore carry infections organisms or allergenic substances. The novel facemask having means for convenient placement and temporary fixation to the face and head has both air particle filtration and humidification means that are easily replenished during use. The present invention is not limited to airline use but may be used in other situations having contaminated or dry air for breathing. The replenishable moistening pads may contain harmless chemicals that may reverse noxious fumes arising from industrial circumstances. The outer mask may be fashioned of a suitable porous colorful and/or pattered material as desired.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A filtering and humidifying face mask comprising:
a base mask adapted for placement over a wearer's nose and mouth; and
an outer mask removably secured to the base mask, the outer mask
selectively retaining:
at least one filtering layer,
at least one humidifying layer.

2. The filtering and humidifying face mask of claim 1, wherein the face mask is configured such that upon donning the face mask, a wearer can remove and replace at least one of the filtering layer and the humidifying layer without altering a position of the base mask.

3. The filtering and humidifying face mask of claim 1, wherein the base mask includes flexible foam sealed margins.

4. The filtering and humidifying face mask of claim 1, wherein the outer mask includes:
a plurality of supporting separators for independently maintaining the filtering layer and the humidifying layer.

5. The filtering and humidifying face mask of claim 3, wherein the support structures are porous.

6. The filtering and humidifying face mask of claim 1, wherein the outer mask is hinged to the base mask.

7. The filtering and humidifying face mask of claim 1, wherein the outer mask is hinged to the base mask at an inferior margin.

8. The filtering and humidifying face mask of claim 1, wherein the at least one humidifying layer comprises a moisture absorbent sponge.

9. The filtering and humidifying face mask of claim 1, wherein the at least one humidifying layer comprises a therapeutic layer including one of a medicament and an aromatherapy additive.

10. The filtering and humidifying face mask of claim 1, further comprising:
a humidity indicator coupled to an exterior of one of the base mask and the outer mask.

11. The filtering and humidifying face mask of claim 1, wherein base mask and the outer mask are configured such that in a closed position, rims of the masks overlap.

12. The filtering and humidifying face mask of claim 1, further comprising:
adjustable straps configured to removably secure the base mask to a head of the wearer.

13. The filtering and humidifying face mask of claim 12, wherein the adjustable straps include a hook and look removable fastening system.

14. A method of humidifying inhaled air comprising:
donning a face mask including:
a base mask and an outer mask removably secured to the base mask, the outer mask including:
at least one filtering layer and at least one humidifying layer; and
periodically replacing one of the filtering layer and the humidifying layer without altering a position of the base mask.
